(19) United States
(12) Patent Application Publication
(10) Pub. No.: US 2014/0051534 A1
(43) Pub. Date: Feb. 20, 2014

(54) Belt Tensioner for a Pump Jack

(71) Applicants: Sheldon Wiebe, Winkler (CA); Garry Wiebe, Winkler (CA)

(72) Inventors: Sheldon Wiebe, Winkler (CA); Garry Wiebe, Winkler (CA)

(21) Appl. No.: 13/587,471

(22) Filed: Aug. 16, 2012

(51) Int. Cl. F16H 7/12

(52) U.S. Cl. 474/135

(57) ABSTRACT

The belt of a pump jack connects an output pulley of a motor and an input drive pulley of the transmission and is tensioned by an idler roller with end flanges which is spring tensioned into engagement with the belt. The idler roller is carried on a base frame adjustable longitudinally and transversely to the belt on a concrete support base. An upstanding support is carried on the base frame including a platform carrying bearings for a pivotally mounted arm extending to the roller for supporting the roller axis transverse to the belt and a spring connects to the arm for applying a force to the arm to press the roller against the belt. The upstanding support and the pivotally mounted arm are all arranged one side of the idler roller so as to present the idler roller to the belt from one side of the belt.

This invention relates to a belt tensioning system of a pump jack.

### BACKGROUND OF THE INVENTION

A pump jack is the over-ground drive for a reciprocating piston pump in an oil well. It is used to mechanically lift liquid out of the well if there is not enough bottom hole pressure for the liquid to flow all the way to the surface. The arrangement is commonly used for onshore wells producing little oil. Pump jacks are common in oil-rich areas.

A pump jack converts the rotary mechanism of the motor to a vertical reciprocating motion to drive the pump shaft, and is exhibited in the characteristic nodding motion. Modern pump jacks are typically powered, where electricity is available by an electric motor. The motor of the pump jack runs a set of pulleys to the transmission which drives a pair of cranks, generally with counterweights on them to assist the motor in lifting the heavy string of rods. The cranks raise and lower one end of an I-beam which is free to move on an A-frame. On the other end of the beam, there is a curved metal box called a Horse Head. A cable called a bridle, connects the horse head to the polished rod, a piston that passes through the stuffing box.

The polished rod has a close fit to the stuffing box, letting it move in and out of the tubing without fluid escaping. The tubing is a pipe that runs to the bottom of the well through which the liquid is produced. The bridle follows the curve of the horse head as it lowers and raises to create a nearly vertical stroke. The polished rod is connected to a long string of rods called sucker rods, which run through the tubing to the down-hole pump, usually positioned near the bottom of the well.

The large diameter input drive pulley of the transmission is driven from a much smaller output pulley of the drive motor through a belt. Due to the large size of the pulley, a relatively long belt is required with significant distance between the output pulley and the input drive pulley of the transmission. Tensioning of such longer belts is problematic since any stretch of the belt significantly changes the tension. Also change in tension can lead to the belt leaving contact with one or other of the pulleys and becoming de-railed halting the pumping action until visited by the service personnel.

### SUMMARY OF THE INVENTION

It is one object of the invention to provide a tensioning device for the belt drive of a pump jack.

According to one aspect of the invention there is provided an apparatus for tensioning the belt drive of a pump jack where the pump jack includes a motor having an output pulley, a transmission including an input drive pulley and a belt interconnecting the output pulley and the input drive pulley, the apparatus comprising:

a base frame for mounting on a support portion of the pump jack adjacent the motor;

an upstanding support carried on the base frame and standing upwardly therefrom to a position adjacent the belt;

an idler roller for engaging the belt with a cylindrical roller surface carried on bearings for rotating about an axis of the cylindrical surface so as to roll on the belt;

a pivotally mounted arm extending from the upstanding support to the roller for supporting the roller axis transverse to the belt;

the arm being mounted on the support for pivotal movement about an arm axis parallel to the roller axis so as to move the roller closer to and further from the belt;

and a spring for applying a force to the arm to press the roller against the belt.

Preferably the base frame, the upstanding support and the pivotally mounted arm are all arranged one side of the idler roller so as to present the idler roller to the belt from one side of the belt. This allows the mounting to be kept free from interference with the belt while allowing adjustment sufficient to allow the mounting to accommodate different arrangements of the pump jack.

Also the spring preferably extends from the mounting arm to a position on the base frame or upstanding support so as to be free from interference with the idler roller and the belt.

Preferably the roller has two end flanges for confining and guiding the belt to prevent the belt from jumping off the pulleys.

Preferably the base frame comprises a plate with slots for bolts by which the position of the plate can be adjusted relative to a support surface for adjustment relative to the belt. The slots preferably extend at right angles to the belt for adjustment of the plate toward and away from the belt. Also the base frame preferably includes a pair of rails arranged parallel to the belt for adjustment of the plate longitudinally of the rails. This arrangement therefore allows the base frame to be adjustable longitudinally and transversely to the belt. In this way the same design can be adjusted to different arrangements of pump jack.

Preferably the upstanding support comprises a plurality of legs connected to the base frame and upstanding therefrom.

Preferably the upstanding support comprises a platform connected to a top of the legs where the platform carries a pair of bearings for supporting a pivot shaft defining the arm axis and the platform is mounted for adjustment of the position of the bearings relative to the legs for movement of the shaft toward and away from the belt.

Preferably the pivotally mounted arm comprises a roller support plate at one end of the idler roller at right angles to the roller axis where the roller support plate is held at right angles to the pivot axis by a brace connected at a position spaced along the pivot axis and extending toward the roller support plate at a position adjacent the idler roller.

Preferably the spring is connected at one end to a depending connecting leg connected to the roller support plate.

Preferably the platform is mounted for adjustment by tilting of the platform about a transverse axis for alignment of the idler roller with the path of the belt. This can be done by adjustment of a length of one or more of the legs.

### BRIEF DESCRIPTION OF THE DRAWINGS

One embodiment of the invention will now be described in conjunction with the accompanying drawings in which:

FIG. 1 is an isometric view of a belt tensioner for a belt of a pump jack according to the present invention where, in relation to the pump jack, the motor drive pulley and the input drive pulley for the transmission only are shown for convenience of illustration.

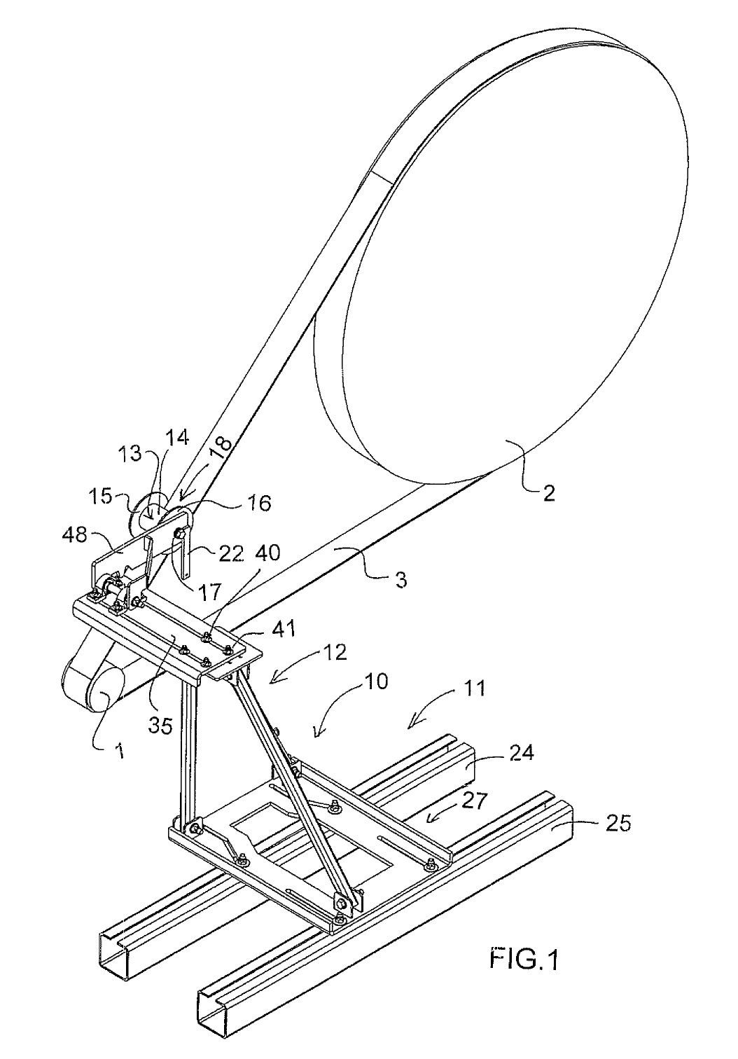

FIG. 2 is a side elevational view of the belt tensioner of FIG. 1.

FIG. 3 is a rear elevational view of the belt tensioner of FIG. 1.

FIG. 4 is an isometric view of the belt tensioner of FIG. 1 with the pulleys omitted and showing the platform in an adjusted position.

In the drawings like characters of reference indicate corresponding parts in the different figures.

### DETAILED DESCRIPTION

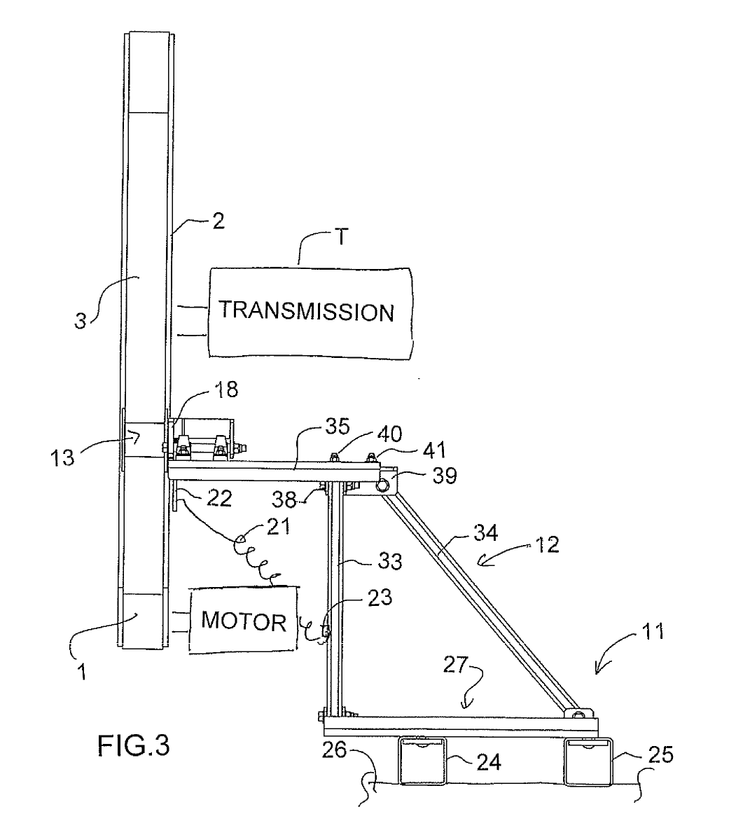

The belt tensioner is used with a belt drive of a pump jack where the pump jack includes a motor M shown schematically in FIG. 3 having an output pulley 1 and a transmission T including an input drive pulley 2 and a belt 3 interconnecting the output pulley and the input drive pulley. The remainder of the pump jack is of a conventional construction well known to persons skilled in the art.

The tensioning apparatus 10 includes a base frame 11 for mounting on a support portion of the pump jack adjacent the motor and typically on a concrete base on which the drive system is mounted.

An upstanding support 12 is carried on the base frame 11 and stands upwardly to a position adjacent the belt 3.

An idler roller 13 has a cylindrical roller surface 14 and two end flanges 15, 16 for engaging and guiding the belt. The roller is carried on internal bearings (not shown) on a shaft 17 for rotating about a roller axis so as to roll on the belt. The shaft 17 is cantilevered outwardly to one side of a pivotally mounted arm 18. The arm extends from a shaft 20 carried in bearings 19 the upstanding support 12 to the roller 13 for supporting the roller axis of the shaft 17 transverse to the belt 3.

The arm 18 is thus mounted on the support 12 for pivotal movement about an arm axis of the shaft 20 which is parallel to the roller axis of the shaft 17 so that pivotal movement of the arm causes the roller 13 to move the roller closer to and further from the belt 3.

A spring 21 extends from a depending leg 22 attached to the arm 18 to a connector 23 on the support 12 for applying a force to the arm 18 to press the roller against the belt 3.

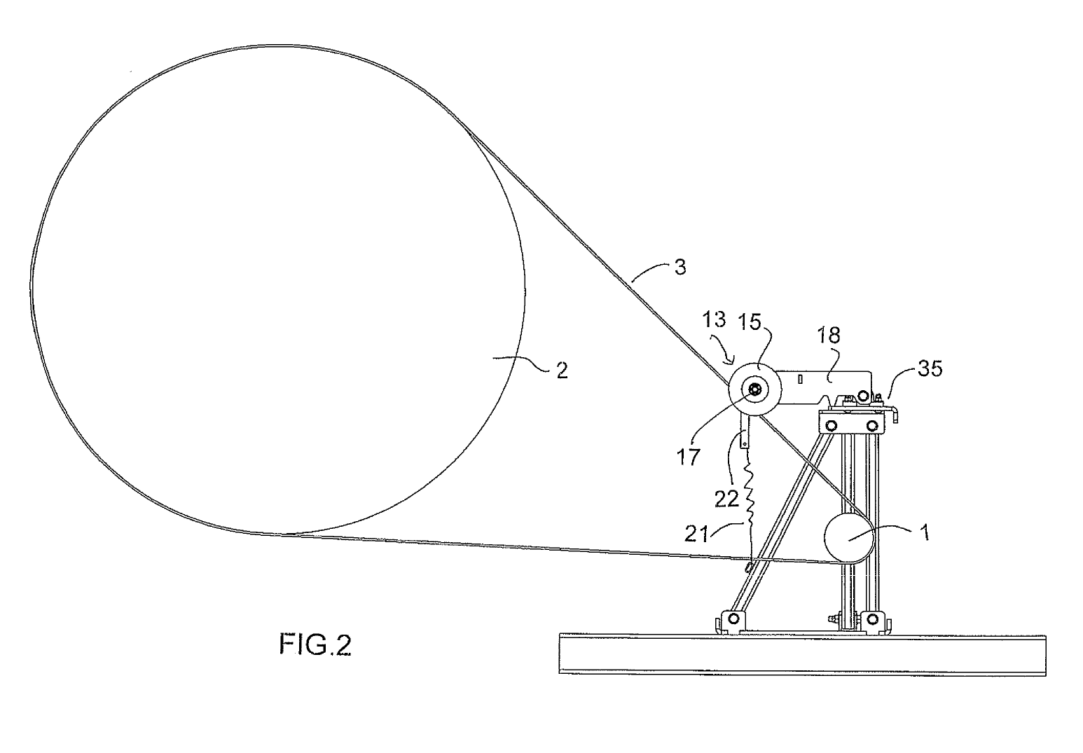

As best shown in FIG. 2, the base frame 11, the upstanding support 12 and the pivotally mounted arm 18 are all arranged one side of the idler roller 13 so as to present the idler roller 13 to the belt 3 wholly from one side of the belt.

The spring 21 extends from the depending leg 22 of the mounting arm 18 to a position at the bracket 23 on upstanding support 12 so as to be kept free from interference with the idler roller 13 and the belt 3.

The base frame 11 includes pair of rails 24 and 25 bolted to the concrete base 26 and arranged parallel to the belt 3. The rails carry a plate 27 lying across the rails with slots 28, 29, 30 and 31 in the plate for bolts connecting to the rails by which the position of the plate 27 can be adjusted relative to the concrete base 26 for adjustment relative to the belt 3.

The slots extend generally at right angles to the belt 3 for adjustment of the plate 27 toward and away from the belt. The rails allow adjustment of the plate longitudinally of the rails and thus longitudinal to the belt. In this way the base frame is adjustable longitudinally and transversely to the belt. The slots 28 and 29 include diagonal portions 28A, 29A in which the spacing between the boils can be adjusted by selecting a required position in the diagonal slot portion. In this way the base frame can be adjusted to different positions on the concrete base to accommodate different locations of the motor M and different support arrangements for the motor M without interfering with those support arrangements.

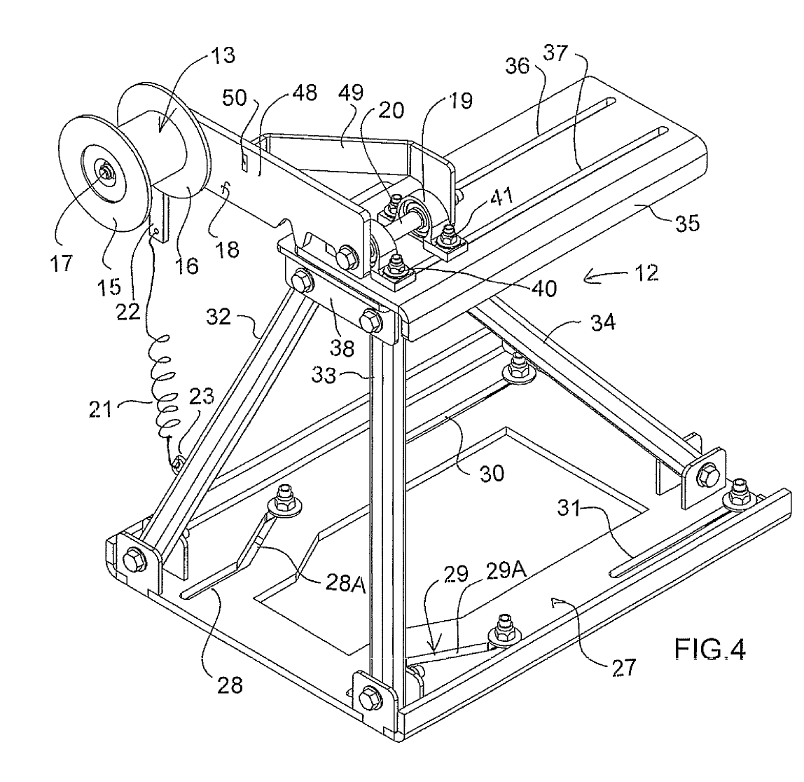

The upstanding support 12 includes three legs 32, 33, 34 connected to the base frame and upstanding therefrom to carry a top platform 35 connected to a top of the legs. Two of the legs 32, 33 are vertical at the end of the base plate 27 adjacent the belt and one leg 34 is diagonal extending downwardly and rearwardly to a far end of the plate 27. A pair of angle brackets 38 and 39 connect the top of the legs to the platform 35 so that the brackets provide bolts 41 and 42 which extend through slots 36, 37 in the platform allowing the platform to be adjusted in position in a direction toward and away from the belt. In FIG. 3 the platform is adjusted so that it is cantilevered out form the legs 32, 33 to support the arm 18 well away from the base plate 27. In FIG. 4 the platform is moved to a position in which it is fully retracted in a direction away from the belt so that the pair of bearings 19 supporting the pivot shaft 20 are located over the brackets 38, 39 and attached by the bolts 40 and 41.

The pivotally mounted arm 18 includes a roller support plate 48 at the end of the shaft 20 adjacent the belt so that the plate 48 stands in a vertical plane at one end of the idler roller 13 at right angles to the shaft 17 and the shaft 20. The roller support plate 48 is held at right angles to the shaft 20 by a brace 49 connected at a position spaced along the shaft 20 on the opposite sides of the bearings 19 and extending toward and connected to the roller support plate 48 at a position 50 adjacent the idler roller 13.

Leg 34 includes an adjustment rod/bolt 34A in order to increase and decrease the length of the leg 34 so as to tilt the complete top platform 35 about a transverse axis at the top of the legs 32 and 33. Although there is provided no hinge or pivot connection at this point, the tilting of the platform allows for further fine alignment/trueness correction of the surface of the belt 3 with the idle roller 13. This is required because not all mechanical fabricated components from various manufactures are a true fitment when combined so that inaccuracies in the path of the belt 3 can occur. Also mechanical wear can cause irregular alignment and thus the fine tuning ability of this adjustable leg 34 provides an extra needed feature.

The pressure of the idler roller against the belt is shown in the embodiment of drawings as a tension spring. However a compression spring can also be used when suitably mounted to apply the spring pressure. Also the pressure application may incorporate an air spring, electric and hydraulic actuators or any combination of each to apply pressure as required.

In this way all of the mounting system is on the side of the vertical plate 48 remote from the belt so as to avoid interfering with the location of the belt and allowing the system to be mounted at different locations on the base 26 to accommodate different design of motor and support.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for tensioning the belt drive of a pump jack where the pump jack includes a motor having an output pulley, a transmission including an input drive pulley and a belt interconnecting the output pulley and the input drive pulley, the apparatus comprising:
a base frame for mounting on a support portion of the pump jack adjacent the motor;
an upstanding support carried on the base frame and standing upwardly therefrom to a position adjacent the belt;
an idler roller for engaging the belt with a cylindrical roller surface carried on bearings for rotating about an axis of the cylindrical surface so as to roll on the belt;
a pivotally mounted arm extending from the upstanding support to the roller for supporting the roller axis transverse to the belt;
the arm being mounted on the support for pivotal movement about an arm axis parallel to the roller axis so as to move the roller closer to and further from the belt;
and a spring for applying a force to the arm to press the roller against the belt.

2. The apparatus according to claim 1 wherein the base frame, the upstanding support and the pivotally mounted arm are all arranged one side of the idler roller so as to present the idler roller to the belt from one side of the belt.

3. The apparatus according to claim 2 wherein the spring extends from the mounting arm to a position on the base frame or upstanding support so as to be free from interference with the idler roller and the belt.

4. The apparatus according to claim 1 wherein the roller has two end flanges for confining and guiding the belt.

5. The apparatus according to claim 1 wherein the base frame comprises a plate with slots for bolts by which the position of the plate can be adjusted relative to a support surface for adjustment relative to the belt.

6. The apparatus according to claim 1 wherein the slots extend at right angles to the belt for adjustment of the plate toward and away from the belt.

7. The apparatus according to claim 6 wherein the base frame includes a pair of rails arranged parallel to the belt for adjustment of the plate longitudinally of the rails.

8. The apparatus according to claim 1 wherein the base frame is adjustable longitudinally and transversely to the belt.

9. The apparatus according to claim 1 wherein the upstanding support comprises a plurality of legs connected to the base frame and upstanding therefrom.

10. The apparatus according to claim 9 wherein the upstanding support comprises a platform connected to a top of the legs.

11. The apparatus according to claim 10 wherein the platform carries a pair of bearings for supporting a pivot shaft defining the arm axis.

12. The apparatus according to claim 10 wherein the platform is mounted for adjustment of the position of the bearings relative to the legs for movement of the shaft toward and away from the belt.

13. The apparatus according to claim 10 wherein the platform is mounted for adjustment by tilting of the platform about a transverse axis for alignment of the idler roller with the path of the belt.

14. The apparatus according to claim 10 wherein the platform is mounted for adjustment by tilting of the platform by adjustment of a length of one or more of the legs.

15. The apparatus according to claim 1 wherein the pivotally mounted arm comprises a roller support plate at one end of the idler roller at right angles to the roller axis.

16. The apparatus according to claim 15 wherein the roller support plate is held at right angles to the pivot axis by a brace connected at a position spaced along the pivot axis and extending toward the roller support plate at a position adjacent the idler roller.

17. The apparatus according to claim 15 wherein the spring is connected at one end to a depending connecting leg connected to the roller support plate.
